(19) United States
(12) Patent Application Publication
(10) Pub. No.: US 2009/0153017 A1
(43) Pub. Date: Jun. 18, 2009

(54) PLASMA DISPLAY PANEL AND METHOD OF MANUFACTURING THE SAME

(76) Inventors: Jae-Ik Kwon, Suwon-si (KR); Yong-Shik Hwang, Suwon-si (KR)

Correspondence Address: CHRISTIE, PARKER & HALE, LLP, PO BOX 7068, PASADENA, CA, 91109-7068, US

(21) Appl. No.: 12/330,392

(22) Filed: Dec. 8, 2008

(30) Foreign Application Priority Data
Dec. 14, 2007 (KR) 10-2007-0130980

(51) Int. Cl. H01J 63/04; H01J 9/26

(52) U.S. Cl. 313/485; 445/25

(57) ABSTRACT

A plasma display panel including: a first substrate; a second substrate facing the first substrate; an electrode sheet including: a barrier rib structure between the first and second substrates defining a plurality of discharge cells in which discharge occurs; a plurality of first discharge electrodes which are separated from each other in the barrier rib structure and extend between the first substrate and the second substrate with portions that surround the discharge cells; and a plurality of second discharge electrodes which are separated from each other and the first discharge electrodes in the barrier rib structure and extend between the first substrate and the second substrate with portions that surround the discharge cells; a phosphor layer on at least one of the first and second substrates; a discharge gas filled in the discharge cells; and a plurality of first aligning marks in the electrode sheet.

### CROSS-REFERENCE TO RELATED PATENT APPLICATION

This application claims priority to and the benefit of Korean Patent Application No. 10-2007-0130980, filed on Dec. 14, 2007, in the Korean Intellectual Property Office, the entire content of which is incorporated herein by reference.

### BACKGROUND OF THE INVENTION

1. Field of the Invention

The present invention relates to a plasma display panel and a method of manufacturing the same, and more particularly, to a plasma display panel manufactured using an aligning mark, and a method of manufacturing the same.

2. Description of the Related Art

A plasma display apparatus, which uses a plasma display panel, is a flat panel display for displaying images using a gas discharge phenomenon, and is expected to be a next generation large flat panel display apparatus due to its display characteristics such as high brightness, high contrast, a low latent image, and a wide viewing angle.

FIG. 1 is a schematic exploded perspective view of a conventional plasma display panel (PDP) 100. The conventional PDP 100 includes: a first substrate 101; pairs of sustain electrodes 106 and 107 on the first substrate 101; a first dielectric layer 109 that covers the pairs of sustain electrodes 106 and 107; a protective layer 111 that covers the first dielectric layer 109; a second substrate 115 facing the first substrate 101; address electrodes 117 disposed parallel to each other on the second substrate 115, and crossing the pairs of sustain electrodes 106 and 107; a second dielectric layer 113 covering the address electrodes 117; a barrier rib structure 114 formed on the second dielectric layer 113; and a phosphor layer 110 formed on a top surface of the second dielectric layer 113 and on sidewalls of the barrier rib structure 114.

In the conventional PDP 100 as described above, light emission efficiency is very low since a large portion of visible light emitted from the phosphor layer 110 is absorbed (approximately 40%) by the pairs of sustain electrodes 106 and 107, the first dielectric layer 109, and the protective layer 111 formed on a bottom surface of the first substrate 101.

In order to address this problem, studies have been conducted to increase the brightness and light emission efficiency of the conventional PDP 100 by disposing discharge electrodes in sidewalls of the barrier rib structure 114 to generate a discharge therefrom. However, even in the case of such a PDP, the brightness is reduced because visible light generated from the phosphor layer still have to pass through a transparent substrate disposed to face a side of a substrate on which an image is displayed.

### SUMMARY OF THE INVENTION

Aspects of embodiments of the present invention are directed toward a plasma display panel (PDP) in which brightness is increased because visible light is concentrated in a direction in which an image is displayed, a discharge space is formed in a suitable position, and etching can be performed on both sides of the PDP, and a method of manufacturing the PDP.

An embodiment of the present invention provides a plasma display panel including: a first substrate; a second substrate facing the first substrate; an electrode sheet including: a barrier rib structure between the first and second substrates defining a plurality of discharge cells in which discharge occurs; a plurality of first discharge electrodes which are separated from each other in the barrier rib structure and extend in a first direction between the first substrate and the second substrate with portions that surround the discharge cells; and a plurality of second discharge electrodes which are separated from each other and the first discharge electrodes in the barrier rib structure and extend in a second direction between the first substrate and the second substrate with portions that surround the discharge cells; a phosphor layer on at least one of the first and second substrates; a discharge gas filled in the discharge cells; and a plurality of first aligning marks in the electrode sheet.

The electrode sheet may further include a plurality of first aligning holes in which the first aligning marks are disposed.

The first aligning holes may be through-holes passing through the electrode sheet.

The first aligning marks may be located at a level substantially the same as that of one of a top surface and a bottom surface of the electrode sheet.

The plasma display panel may further include second aligning marks on locations that do not overlap with the first aligning marks in the electrode sheet.

The electrode sheet may further include second aligning grooves in which the second aligning marks are disposed.

The second aligning marks may be located at a level substantially the same as that of the other one of the top surface and the bottom surface of the electrode sheet.

The second aligning marks may be located in the second aligning grooves at a level lower than that of the other one of the top surface and the bottom surface of the electrode sheet.

The first discharge electrodes and the second discharge electrodes may be parallel to each other, and further may include a plurality of address electrodes which extend in a third direction crossing the first and second directions of the first and second discharge electrodes to provide a plurality of crossing regions corresponding to the discharge cells.

The address electrodes may be between the second substrate and the electrode sheet.

Another embodiment of the present invention provides a method of manufacturing a plasma display panel, the method including: preparing an electrode sheet including: a plurality of first discharge electrodes which are separated from each other in a barrier rib structure and have portions that surround discharge cells; and a plurality of second discharge electrodes which are separated from each other and the first discharge electrodes in the barrier rib structure and have portions that the surround discharge cells; forming first aligning marks in one of a top surface and a bottom surface of the electrode sheet; forming sacrifice layers on both the top and bottom surfaces of the electrode sheet; aligning exposure masks to be aligned to the first aligning marks on the top and bottom surfaces of the electrode sheet; patterning the sacrifice layers on the top and bottom surfaces of the electrode sheet by exposing the electrode sheet; forming discharge cell regions between the discharge electrodes by etching the top and bottom surfaces of the electrode sheet exposed through the patterned sacrifice layers; removing the sacrifice layers; and frit sealing first and second substrates facing each other by interposing the electrode sheet between the first and second substrates.

The first aligning marks may be in first aligning holes formed through the electrode sheet.

The preparing of the electrode sheet may include: preparing a first dielectric layer; forming the first discharge electrodes on the first dielectric layer; forming a second dielectric layer covering the first discharge electrodes on the first dielectric layer; forming the second discharge electrodes on the second dielectric layer; and forming a third dielectric layer covering the second discharge electrodes on the second dielectric layer.

The preparing of the electrode sheet further may include baking the electrode sheet in which the first, second, and third dielectric layers are formed.

The method may further include forming second aligning marks in the electrode sheet such that the second aligning marks are formed in locations that do not overlap with the first aligning marks.

The method may further include forming a protective layer on sidewalls defining the discharge cells.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a schematic exploded perspective view of a conventional plasma display panel (PDP);

FIG. 2 is a schematic exploded perspective view of a PDP according to an embodiment of the present invention;

FIG. 3 is a schematic partial cross-sectional view taken along line III-III of FIG. 2;

FIG. 4 is a schematic perspective view of discharge cells and first and second discharge electrodes, according to an embodiment of the present invention;

FIG. 5 is a schematic exploded perspective view of an exposure mask on an electrode sheet as utilized in a method of manufacturing a PDP, according to an embodiment of the present invention;

FIG. 6 is a schematic plan view of the electrode sheet on which exposed sacrifice layers, each having a pattern thereon, are formed;

FIGS. 7A through 7M are schematic partial cross-sectional views taken along line VII-VII of FIG. 6 for explaining a method of manufacturing the PDP, according to an embodiment of the present invention; and

FIG. 8 is a schematic partial cross-sectional view of a PDP, according to another embodiment of the present invention.

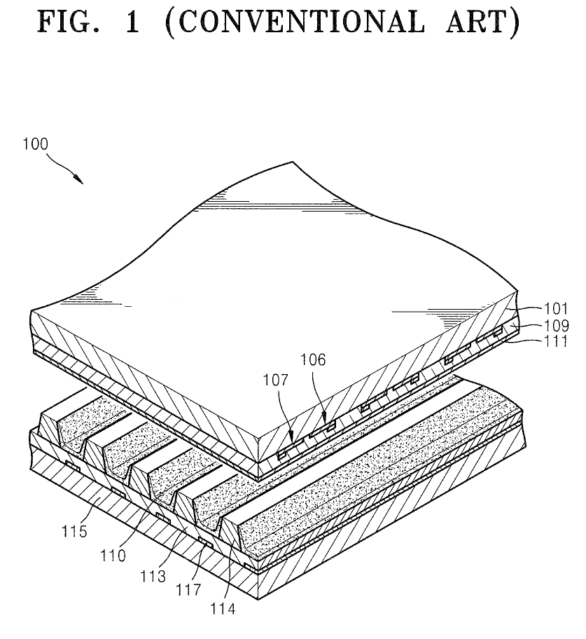

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit and scope of the present invention. Accordingly, the drawings and description are to be regarded as illustrative in nature and not restrictive. Like reference numerals designate like elements throughout the specification.

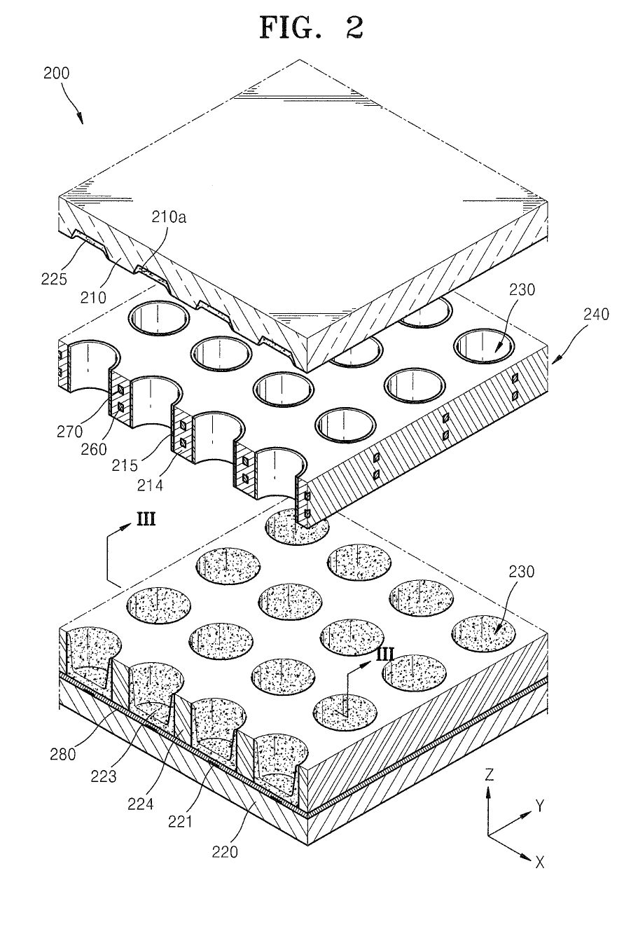

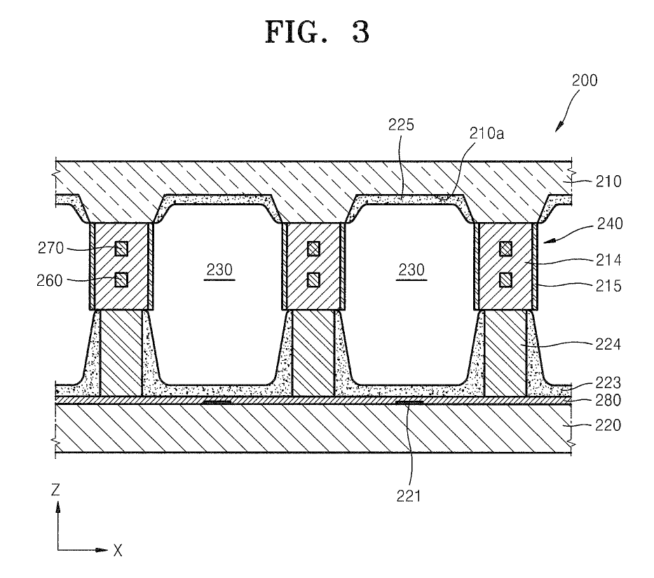

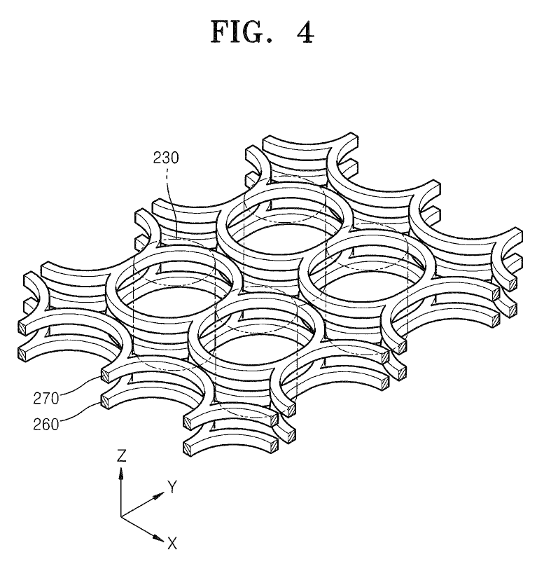

FIG. 2 is a schematic exploded perspective view of a plasma display panel (PDP) 200 according to an embodiment of the present invention. FIG. 3 is a schematic cross-sectional view taken along line III-III of FIG. 2, and FIG. 4 is a schematic perspective view of discharge cells 230 and first and second discharge electrodes 260 and 270, according to an embodiment of the present invention.

The PDP 200 includes a first substrate 210, a second substrate 220, an electrode sheet 240, and a first phosphor layer 223.

The first substrate 210 is formed of a high optical transmittance material, such as glass. However, the first substrate 210 can be colored in order to increase bright room contrast by reducing reflection brightness of the first substrate 210. The second substrate 220 is disposed a distance (e.g., a predetermined distance) apart from the first substrate 210 to face the first substrate 210. The first and second substrate 210 and 220 together with a barrier rib structure define the discharge cells 230 between the first and second substrates 210 and 220. The discharge cells 230 are a space for generating discharges. The second substrate 220 is formed of a high optical transmittance material, such as glass, and can be colored like the first substrate 210. Visible light generated from the discharge cells 230 can be emitted to the outside of the PDP 200 through the first substrate 210.

Referring to FIG. 2, the PDP 200 includes the barrier rib structure composed of a first barrier rib 214 and a second barrier rib 224, which define the discharge cells 230. However, the barrier rib structure is an example, and the present invention is not limited thereto. That is, the first barrier rib 214 and the second barrier rib 224 can be integrally formed. For example, the barrier rib structure can be formed by extending the height of the first barrier rib 214 to as much as the height of the second barrier rib 224 when the first barrier 214 is formed. In the present embodiment, for convenience of explanation, the barrier rib structure is formed to include the first barrier rib 214 and the second barrier rib 224.

The first barrier rib 214 is depicted as defining the discharge cells 230 having a circular horizontal cross-section; however, the present invention is not limited thereto. That is, the first barrier rib 214 can be formed to define the discharge cells 230 to have a polygonal shape horizontal cross-section, such as triangular, rectangular, or a pentagonal shape, or an oval shape horizontal cross-section, besides the circular shape horizontal cross-section.

A plurality of electrode pairs are disposed in the first barrier rib 214, such that each of the electrode pairs includes the first discharge electrode 260 and the second discharge electrode 270. Referring to FIG. 4, the first discharge electrode 260 and the second discharge electrode 270 are formed to encircle or surround the discharge cells 230 and extend in an X direction. In this structure, the first discharge electrode 260 and the second discharge electrode 270 form an electrode pair, so as to generate a discharge in the discharge cells 230.

The PDP 200 according to an embodiment of the present embodiment has a three-electrode structure, and thus, address electrodes 221 are on the second substrate 220 to cross an extending direction of the first discharge electrode 260 and the second discharge electrode 270 with an angle (e.g., a predetermined angle), such that the address electrodes 221 extend to correspond to the discharge cells 230. Referring to FIG. 2, the address electrodes 221 extend in a Y direction substantially perpendicular to the extending direction (e.g., the x direction) of the first discharge electrode 260 and the second discharge electrode 270.

Alternatively, the PDP 200 may have a two-electrode structure, apart from the electrode structure as described above. In this case, the first discharge electrode 260 and the second discharge electrode 270 can extend substantially perpendicularly to cross each other (respectively X and Y directions). In this case, since a particular discharge cell 230 can be selected at crossing regions between the first discharge electrode 260 and the second discharge electrode 270, an additional address electrode is unnecessary. Thus, in this case, one of the first discharge electrode 260 and the second discharge electrode 270 functions as a scanning and sustaining electrode, and the other one functions as an addressing and sustaining electrode. The electrode sheet 240 includes the first and second discharge electrodes 260 and 270 and the first barrier rib 214.

Referring to FIG. 2, since the first discharge electrodes 260 and the second discharge electrodes 270 are in the first barrier rib 214, the first discharge electrodes 260 and the second discharge electrodes 270 do not reduce the transmittance of visible light, and thus, can be formed of a conductive metal, such as Al or Cu, that does not cause a voltage drop, so the first discharge electrodes 260 and the second discharge electrodes 270 can stably transmit signals.

The first barrier rib 214 reduces (or prevents) a direct electrical connection between the adjacent first discharge electrode 260 and the second discharge electrode 270, and reduces (or prevents) the first and second discharge electrodes 260 and 270 from being damaged due to colliding of positive ions or electrons on the first and second discharge electrodes 260 and 270. Also, the first barrier rib 214 functions to accumulate wall charges due to the induced charges (or discharges), and thus, the first barrier rib 214 is formed of a dielectric material.

As depicted in FIGS. 2 and 3, protective layers 215 can be formed on sidewalls of the first barrier rib 214 to reduce or prevent the first barrier rib 214 from being damaged by plasma particles. Also, the protective layers 215 reduce a discharge voltage by emitting secondary electrons. The protective layers 215 can be formed by depositing MgO on the sidewalls of the first barrier rib 214.

The second barrier rib 224 is between the first barrier rib 214 and the second substrate 220. The second barrier rib 224, together with the first barrier rib 214, define the discharge cells 230. The second barrier rib 224, like the first barrier rib 214, is formed to define the discharge cells 230 having a circular shaped horizontal cross-section, however, the present embodiment is not limited thereto, that is, as long as the second barrier rib 224 can define the discharge cells 230, the second barrier rib 224 can be formed in various suitable patterns.

Also, the first barrier rib 214 and the second barrier rib 224 can have different shapes from each other, however, for convenience of manufacturing, the first barrier rib 214 and the second barrier rib 224 may have the same shape. As described above, the first barrier rib 214 and the second barrier rib 224 can be integrally formed, thus, in this case, the first barrier rib 214 and the second barrier rib 224 have the same shape.

The first phosphor layer 223 is formed on sidewalls of the second barrier rib 224, and on a bottom surface of the second substrate 220 (or on a surface of the second substrate facing the first substrate). The first phosphor layers 223 include a component that emits visible light due to excitation of the component by ultraviolet (UV) rays. Here, the first phosphor layer can be a red light emitting phosphor layer including a phosphor such as Y(V,P)O₄:Eu, a green light emitting phosphor layer including a phosphor such as Zn₂SiO₄:Mn or YBO₃:Tb, or a blue light emitting phosphor layer including a phosphor such as BAM:Eu.

A lower dielectric layer 280 is formed between the second substrate 220 and the first phosphor layer 223 to cover the address electrodes 221. When a discharge occurs in the discharge cells 230, visible light generated in the discharge cells 230 can be emitted to the outside of the PDP 200 by being transmitted through the second substrate 220 that is formed of a transparent material. In this case, the visible light can be externally emitted in both directions through the first substrate 210 and the second substrate 220.

A plurality of grooves 210a can be formed in the first substrate 210 to correspond to the discharge cells 230. The grooves 210a can be formed for each discharge cell 230, or one groove 210a corresponding to multiple discharge cells 230 can be formed. The thickness of the first substrate 210 is reduced due to the formation of the grooves 210a, and thus, visible light transmittance can be increased.

A second phosphor layer 225 composed of red, green, and blue phosphor layers is disposed in the grooves 210a. The area of the second phosphor layer 225 (or each of the second phosphor layers 225) is increased due to the groove 210a, and thus, brightness and light emission efficiency are increased. The second phosphor layer 225 can be formed of the same (or substantially the same) materials as the first phosphor layer 223.

The first substrate 210 and the second substrate 220 are sealed using a sealing material such as frit glass. After the first substrate 210 and the second substrate 220 are sealed, a discharge gas, such as Ne gas, Xe gas, or a gas mixture of Ne and Xe, can be filled in the discharge cells 230.

A method of operating the PDP 200 having the above structure according to an embodiment of the present invention will now be described in more detail below.

An address discharge is generated between the address electrodes 221 and the first discharge electrode 260, and, as a result of the address discharge, discharge cells 230 in which a sustaining discharge will be generated are selected. Then, when an alternating current sustaining voltage is applied between the first discharge electrode 260 and the second discharge electrode 270 of the selected discharge cells 230, a sustaining discharge is generated between the first discharge electrode 260 and the second discharge electrode 270. Due to the sustaining discharge, the energy level of the excited discharge gas is reduced, and thus, UV rays are emitted from the discharge gas to excite the first and second phosphor layers 223 and 225. While the energy level of the first and second phosphor layers 223 and 225 is reduced, visible light is emitted from the first and second phosphor layers 223 and 225 to display an image.

The sustaining discharge of the PDP 200 according to the present embodiment has an enhancement in that the sustaining discharge occurs on sidewalls of the first and second barrier ribs 214 and 224, and occurs in a relatively wide area. Also, the sustaining discharge in the present embodiment is formed in a closed loop curve along the sidewalls of the first and second barrier ribs 214 and 224, and gradually diffuses to the center of the discharge cells 230. Thus, the volume of the region where the sustaining discharge occurs is increased. Also, the sustaining discharge mainly occurs in a central region of each of the discharge cells 230, and ion sputtering to the first and second phosphor layers 223 and 225 is reduced (or prevented). Thus, although the same image is displayed for a period of time, a permanent latent image is not generated. As a result, the amount of visible light that progresses towards the first substrate 210, on which an image is displayed, is increased, and thus, an overall brightness is increased.

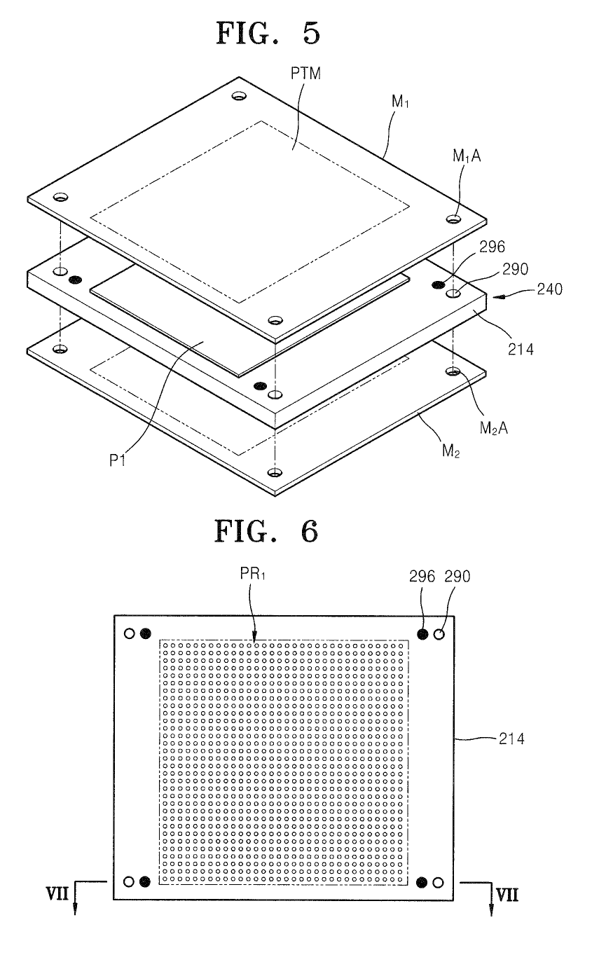

FIG. 5 is a schematic exploded perspective view of first and second exposure masks M1 and M2 on the electrode sheet 240 in a method of manufacturing the PDP 200, according to an embodiment of the present invention. FIG. 6 is a schematic plan view of the electrode sheet 240 on which exposed sacrifice layers having a pattern thereon are formed.

A method of manufacturing the PDP 200 according to an embodiment of the present invention, can be utilized to form a space corresponding to the discharge cells 230 in the first barrier rib 214. In order to correctly designate locations where the discharge cells 230 should be formed and as a preliminary etching process for forming the discharge cells 230 in the first barrier rib 214, a method of forming the surfaces of the first and second barrier ribs 214 and 224, in which the discharge cells 230 are formed, is provided such that the surfaces of the first and second barrier ribs 214 and 224 are uniformly formed in a vertical direction without a slope by simultaneously (or concurrently) etching the top and bottom surfaces of the electrode sheet 240 in which the first and second discharge electrodes 260 and 270 are buried (or embedded with). In order to correctly (or suitably) align patterns of first and second sacrifice layers P1 and P2 on locations (e.g., predetermined locations) of the top and bottom surfaces of the electrode sheet 240, the first and second sacrifice layers P1 and P2 that expose a portion of the electrode sheet 240 that is to be etched are formed by using a mask formed on the electrode sheet 240.

Here, the first and second sacrifice layers P1 and P2 are respectively formed on the top and bottom surfaces of the electrode sheet 240 that includes the first barrier rib 214. In FIG. 5, the first sacrifice layer P1 is formed on the top surface of the first barrier rib 214. The second sacrifice layer P2 is formed on a bottom surface of the first barrier rib 214. First and second masks M₁ and M₂ are respectively formed on the top and bottom surfaces of the electrode sheet 240. Also, a first mask aligning hole M₁A and a second mask aligning hole M₂A are respectively formed on locations (e.g., predetermined locations) of the first and second masks M₁ and M₂, such that the first and second mask aligning holes M₁A and M₂A are formed outside of mask patterns PTM that are formed on the first and second masks M₁ and M₂.

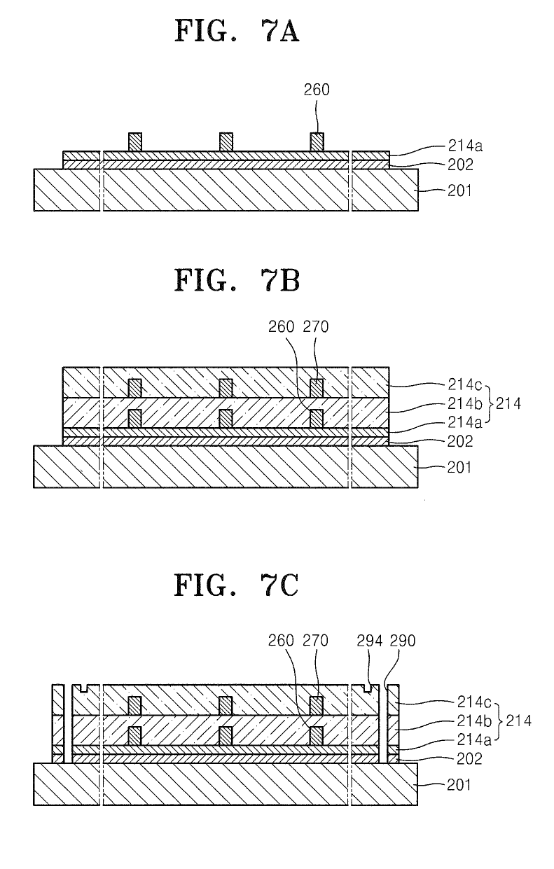

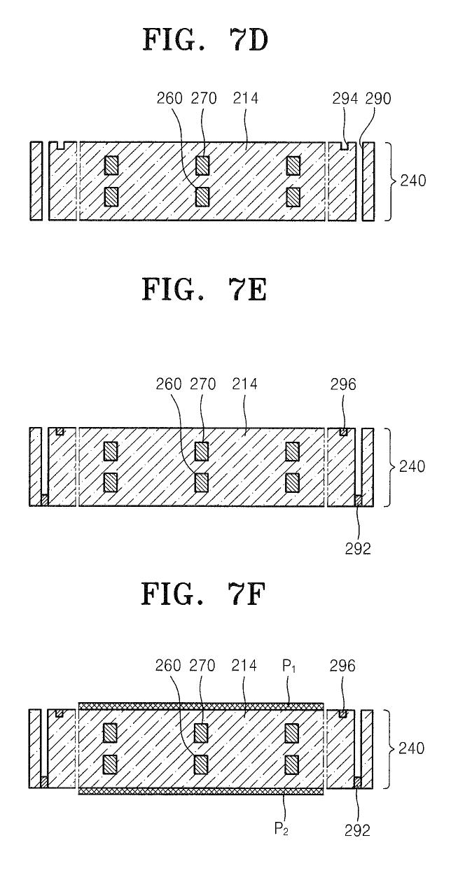

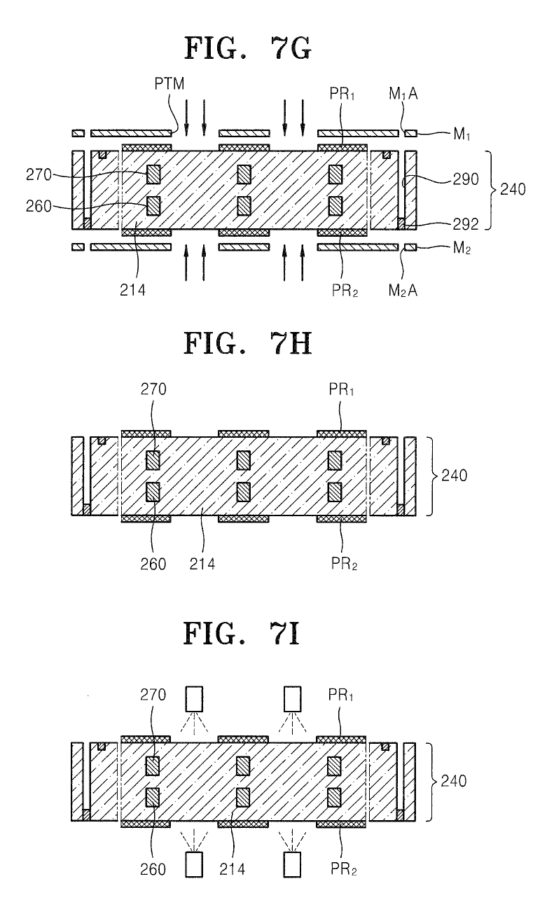

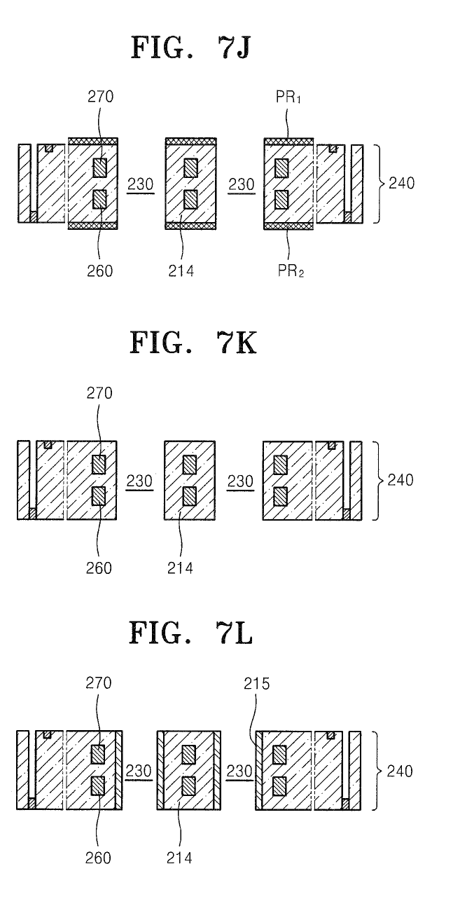

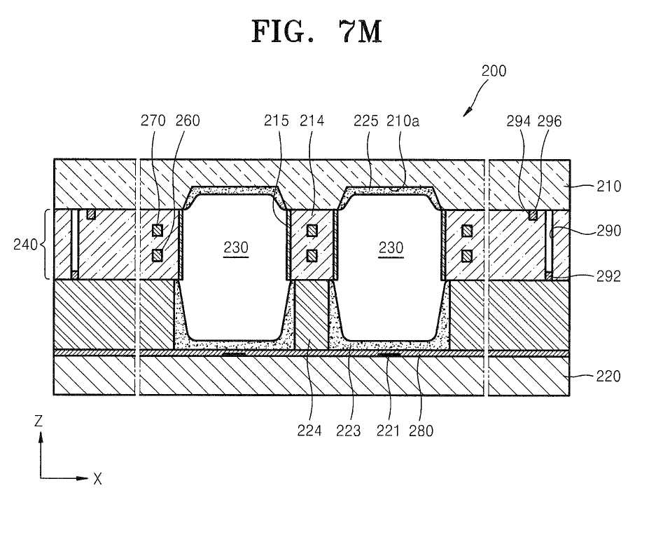

In order to align the first and second masks M₁ and M₂ on the electrode sheet 240, the first and second masks M₁ and M₂ are disposed by aligning the first and second mask aligning holes M₁A and M₂A, respectively formed in the first and second masks M₁ and M₂, with corresponding aligning marks that are formed corresponding to first aligning holes 290 formed in the electrode sheet 240. The aligning marks can be formed corresponding to the first aligning holes 290 in the electrode sheet 240 that includes the first barrier rib 214. The configuration of the aligning marks and the first aligning holes 290, which correspond to the aligning marks, will be described in connection with FIGS. 7A through 7M.

FIGS. 7A through 7M are schematic partial cross-sectional views taken along line VII-VII of FIG. 6 for explaining a method of manufacturing the PDP 200, according to an embodiment of the present invention. In FIGS. 7A through 7M, a portion of a structure of the discharge cells 230 is omitted for ease of illustration.

Referring to FIG. 7A, a separation layer 202 is formed on a base substrate 201, and a first dielectric layer 214a is formed on the separation layer 202. The first dielectric layer 214a can be formed using, for example, a printing method. The first discharge electrodes 260 having a pattern (e.g., a predetermined pattern) are formed on the first dielectric layer 214a to a shape as depicted in FIG. 4. For example, the first discharge electrodes 260 can be formed using a method that utilizes an optical reaction (or an optical formation process).

Referring to FIG. 7B, a second dielectric layer 214b covering the first discharge electrodes 260 is formed on the first dielectric layer 214a. The second discharge electrodes 270 are disposed on the second dielectric layer 214b to a shape as depicted in FIG. 4. A third dielectric layer 214c covering the second discharge electrodes 270 is formed on the second dielectric layer 214b. The first through third dielectric layers 214a, 214b, and 214c form the first barrier rib 214, which can be formed of a ceramic material.

Referring to FIG. 7C, after forming the first and second discharge electrodes 260 and 270 in the first barrier rib 214, the first aligning holes 290 are formed in corners of the first barrier rib 214. Second aligning grooves 294 are formed in the top part of the first barrier rib 214 to not overlap with the first aligning holes 290.

The first aligning holes 290 and the second aligning grooves 294 are formed in positions (e.g., predetermined positions) in the first barrier rib 214 to not overlap with the first and second discharge electrodes 260 and 270, and in one embodiment, are formed on edges of the first barrier rib 214.

The first aligning holes 290 and the second aligning grooves 294 can be formed together with the first through third dielectric layers 214a, 214b, and 214c when the first through third dielectric layers 214a, 214b, and 214c are formed, or can also be formed through an additional process after forming the first barrier rib 214.

When the structure that includes the first barrier rib 214 is baked, and the base substrate 201 and the separation layer 202 are removed afterwards, a structure shown in FIG. 7D is obtained. At this point, the first through third dielectric layers 214a, 214b, and 214c are integrated as the first barrier rib 214.

Referring to FIG. 7E, first aligning marks 292 and second aligning marks 296 are respectively formed in the first aligning holes 290 and second aligning grooves 294.

The first aligning marks 292 are formed in the first aligning holes 290 at the same (or substantially the same) level as the bottom surface of the electrode sheet 240. Also, the second aligning marks 296 are formed in the second aligning grooves 294 at the same (or substantially the same) level as the top surface of the electrode sheet 240. Thus, the first aligning marks 292 are exposed at the top surface of the electrode sheet 240 without being buried by (or embedded within) the first dielectric layer 214a, which is the lowermost layer of the first barrier rib 214 that constitutes the electrode sheet 240, and the second aligning marks 296 are exposed from the top surface of the electrode sheet 240 without being buried by (or embedded within) the third dielectric layer 214c, which is the uppermost layer of the first barrier rib 214.

Referring to FIG. 7F, the first sacrifice layer P1 and the second sacrifice layer P2 are respectively coated on the top and bottom surfaces of the first barrier rib 214 of the electrode sheet 240. The first and second sacrifice layers P1 and P2 may be a dry film photoresist, and are formed through a laminating process. The first sacrifice layer P1 and the second sacrifice layer P2 may be coated on a central region of the electrode sheet 240, so as not to cover the first and second aligning marks 292 and 296.

Referring to FIG. 7G, as depicted in FIG. 5, the first and second masks M₁ and M₂ are respectively disposed on the top and bottom surfaces of the first barrier rib 214 of the electrode sheet 240. In this process, the first and second masks M₁ and M₂ are aligned by using the first aligning marks 292 formed in the first aligning holes 290 of the electrode sheet 240 as a reference for alignment. The predetermined mask patterns (PTMs) are respectively formed on the first and second masks M₁ and M₂. Thus, the first and second sacrifice layers P₁ and P₂, respectively formed on the top and bottom surfaces of the first barrier rib 214 of the electrode sheet 240, are exposed through the PTMs of the first and second masks M₁ and M₂.

Through an exposing process in which UV rays are selectively radiated on the first and second sacrifice layers P₁ and P₂ formed on the top and bottom surfaces of the electrode sheet 240 through the first and second masks M₁ and M₂ and a consecutive developing process, as depicted in FIG. 7H, the first sacrifice layer PR₁ and the second sacrifice layer PR₂ are respectively formed on the top and bottom surfaces of the electrode sheet 240, such that the first and second sacrifice layers PR₁ and PR₂ cover a portion of the first barrier rib 214, which corresponds to the first and second discharge electrodes 260 and 270. Thus, the first and second sacrifice layers PR₁ and PR₂ may be substantially aligned with respect to each other.

Then, referring to FIG. 7I, the top and bottom surfaces of the first barrier rib 214 are etched using the first and second sacrifice layers PR1 and PR2 as etch preventive (or blocking) films. As a result of the etching of the top and bottom surfaces of the first barrier rib 214, portions corresponding to the first and second discharge electrodes 260 and 270, and the discharge cells 230 between the first and second discharge electrodes 260 and 270, are formed. Referring to FIG. 7J, the etching process is performed until the discharge cell space is completely perforated.

Then, once the first and second sacrifice layers PR₁ and PR₂ are removed, an electrode sheet structure, in which the discharge cells 230 are formed, is formed as depicted in FIG. 7K.

Referring to FIG. 7L, a protective layer 215 is formed on sidewalls of the electrode sheet 240 in which the discharge cell space is formed using a suitable method.

FIG. 7M is a cross-sectional view of an assembling state of the electrode sheet 240, formed through the processes described above, with the first substrate 210 and the second substrate 220 being assembled using frit glass. When the first and second substrates 210 and 220 are arranged with the electrode sheet 240, the aligning holes or aligning marks can be used for alignment like in the mask arrangement for etching.

As depicted in FIG. 7M, the first aligning holes 290 and the second aligning grooves 294 and the first and second aligning marks 292 and 296 used for correct alignment in the manufacturing processes are formed on edges of the electrode sheet 240 of the PDP 200.

If the PDP of FIG. 3 and FIG. 7M are compared, the view of the PDP 200 of FIG. 3 is a partial cross-sectional view of a specific portion of the discharge cells 230, which corresponds to a display unit in the PDP 200; and, the view of the PDP 200 of FIG. 7M is a cross-sectional view of a portion of the discharge cells 230, which is repeated in an overall cross-sectional view of the PDP 200.

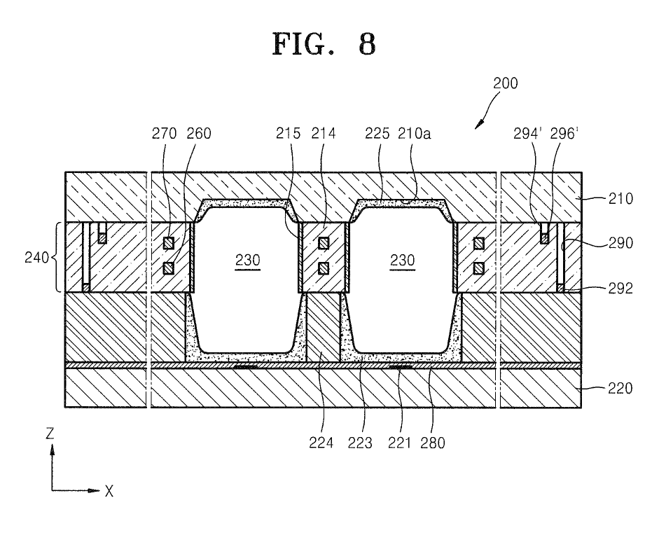

FIG. 8 is a partial cross-sectional view of a portion of the cross-sectional view of the PDP 200 of FIG. 7M, according to another embodiment of the present invention.

Referring to FIG. 8, and comparing with FIG. 7M, the second aligning marks 296′ are formed in the second aligning grooves 294′ at a level lower than the top surface of the electrode sheet 240. That is, the second aligning marks 296′ are formed in the second aligning grooves 294′, and are not directly exposed from the top surface of the electrode sheet 240.

According to an embodiment of the present invention, the use of aligning holes and aligning marks as described above can increase the precision of the arrangements between constituent elements or between a constituent element and a manufacturing apparatus, and also enables the exposure of both sides of an electrode sheet to etch both sides of the electrode sheet.

Thus, a PDP according to an embodiment of the present invention may have increased brightness.

According to a method of manufacturing a PDP of an embodiment of the present invention, in forming a hole for forming a discharge space in an electrode sheet, the hole can be formed in a correct (or suitably aligned) position.

In the method of manufacturing a PDP according to an embodiment of the present invention, etching can be performed on both sides of an electrode sheet.

In the method of manufacturing a PDP according to an embodiment of the present invention, in assembling the PDP, correct (or suitable) alignment of constituent elements of the PDP can be achieved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel comprising:
a first substrate;
a second substrate facing the first substrate;
an electrode sheet comprising: a barrier rib structure between the first and second substrates defining a plurality of discharge cells in which discharge occurs; a plurality of first discharge electrodes which are separated from each other in the barrier rib structure and extend in a first direction between the first substrate and the second substrate with portions that surround the discharge cells; and a plurality of second discharge electrodes which are separated from each other and the first discharge electrodes in the barrier rib structure and extend in a second direction between the first substrate and the second substrate with portions that surround the discharge cells;
a phosphor layer on at least one of the first and second substrates;
a discharge gas filled in the discharge cells; and
a plurality of first aligning marks in the electrode sheet.

2. The plasma display panel of claim 1, wherein the electrode sheet further comprises a plurality of first aligning holes in which the first aligning marks are disposed.

3. The plasma display panel of claim 2, wherein the first aligning holes are through-holes passing through the electrode sheet.

4. The plasma display panel of claim 3, wherein the first aligning marks are located at a level substantially the same as that of one of a top surface and a bottom surface of the electrode sheet.

5. The plasma display panel of claim 4, further comprising second aligning marks on locations that do not overlap with the first aligning marks in the electrode sheet.

6. The plasma display panel of claim 5, wherein the electrode sheet further comprises second aligning grooves in which the second aligning marks are disposed.

7. The plasma display panel of claim 6, wherein the second aligning marks are located at a level substantially the same as that of the other one of the top surface and the bottom surface of the electrode sheet.

8. The plasma display panel of claim 6, wherein the second aligning marks are located in the second aligning grooves at a level lower than that of the other one of the top surface and the bottom surface of the electrode sheet.

9. The plasma display panel of claim 1, wherein the first discharge electrodes and the second discharge electrodes are parallel to each other, and further comprising a plurality of address electrodes which extend in a third direction crossing the first and second directions of the first and second discharge electrodes to provide a plurality of crossing regions corresponding to the discharge cells.

10. The plasma display panel of claim 9, wherein the address electrodes are between the second substrate and the electrode sheet.

11. A method of manufacturing a plasma display panel, the method comprising:
preparing an electrode sheet comprising: a plurality of first discharge electrodes which are separated from each other in a barrier rib structure and have portions that surround discharge cells; and a plurality of second discharge electrodes which are separated from each other and the first discharge electrodes in the barrier rib structure and have portions that the surround discharge cells;
forming first aligning marks in one of a top surface and a bottom surface of the electrode sheet;
forming sacrifice layers on both the top and bottom surfaces of the electrode sheet;
aligning exposure masks to be aligned to the first aligning marks on the top and bottom surfaces of the electrode sheet;
patterning the sacrifice layers on the top and bottom surfaces of the electrode sheet by exposing the electrode sheet;
forming discharge cell regions between the discharge electrodes by etching the top and bottom surfaces of the electrode sheet exposed through the patterned sacrifice layers;
removing the sacrifice layers; and
frit sealing first and second substrates facing each other by interposing the electrode sheet between the first and second substrates.

12. The method of claim 11, wherein the first aligning marks are in first aligning holes formed through the electrode sheet.

13. The method of claim 12, wherein the preparing of the electrode sheet comprises:
preparing a first dielectric layer;
forming the first discharge electrodes on the first dielectric layer;
forming a second dielectric layer covering the first discharge electrodes on the first dielectric layer;
forming the second discharge electrodes on the second dielectric layer; and
forming a third dielectric layer covering the second discharge electrodes on the second dielectric layer.

14. The method of claim 13, wherein the preparing of the electrode sheet further comprises baking the electrode sheet in which the first, second, and third dielectric layers are formed.

15. The method of claim 11, further comprising forming second aligning marks in the electrode sheet such that the second aligning marks are formed in locations that do not overlap with the first aligning marks.

16. The method of claim 11, further comprising forming a protective layer on sidewalls defining the discharge cells.
